(19) United States
(12) Patent Application Publication
(10) Pub. No.: US 2020/0055137 A1
(43) Pub. Date: Feb. 20, 2020

(54) Precision Wire Guide For A Welding Consumable

(71) Applicant: Keyhole Tig Limited, South Australia (AU)

(72) Inventors: Adam POOLE, South Australia (AU); Ronak SANGHANI, South Australia (AU)

(73) Assignee: Keyhole Tig Limited, South Australia (AU)

(21) Appl. No.: 16/497,774

(22) PCT Filed: Mar. 23, 2018
(86) PCT No.: PCT/AU2018/050269

§ 371 Date: Sep. 25, 2019

(30) Foreign Application Priority Data
Mar. 27, 2017 (AU) 2017901088

(51) Int. Cl. B23K 9/12; B23K 9/133

(52) U.S. Cl. CPC B23K 9/122; B23K 9/133

(57) ABSTRACT

A wire guide including a bracket for securing the wire guide to an external support, a housing, a holder for holding a nozzle extension, a main spring and an adjustment mechanism, and wherein the main spring is configured to allow the holder to float within the housing whilst a first end of the holder extends through an aperture formed in the housing and has a position adjustable with reference to the housing by the adjustment mechanism.

### TECHNICAL FIELD OF INVENTION

The present invention relates to a wire guide fora welding consumable.

### BACKGROUND OF INVENTION

During a TIG welding operation, a welding consumable (filler) is often fed into the molten welding pool that is created by an electric arc. The welding consumable or filler wire is added to the weld pool to provide additional material to flow into any space between the two surfaces being joined.

Although manual feed of the consumable into the molten weld pool is possible in some situations, the weld location may not always allow for it. Accordingly, it is more preferable to make use of a feeding device that winds the consumable off a reel and feeds it to the welding pool via a wire guide.

FIG. 1 of E P patent application 0194045 (E P0194045) illustrates a TIG welding arrangement that includes a feeding device 6 that feeds filler wire 5 (consumable) off a reel and into the molten weld pool. The filler wire 5 is passed through a conduit 7 and a wire guide 9 that includes a contact tip 8. Contact tip 8 is shown connected to a power source 10 to enable current to be fed into the filler wire 5 to increase its melting rate (if required).

FIG. 2 of E P0194045 shows a semi-automatic TIG welding arrangement in which the wire guide 9 is secured to a torch body 11 and the filler wire 5 is automatically fed at a predetermined rate by a wire feeding device. To ensure that the filler wire 5 is fed to the proper position of the molten weld pool 12, a manual adjustor 13 is provided for finely adjusting the filling position of the filler wire 5. Adjustor 13 is connected to the contact tip 8 and is also mounted to the torch body 11. Accordingly, the contact tip 8 and thus the wire 5 moves together with the torch body 11.

The present invention seeks to provide a wire guide that includes an improved arrangement for adjusting the positioning of the filler wire with respect to the molten weld pool formed by a welding device.

The discussion of the background to the invention herein is included to explain the context of the invention. This is not to be taken as an admission that any of the material referred to was published, known or part of the common general knowledge as at the priority date of this application.

### SUMMARY OF INVENTION

According to the present invention there is provided a wire guide including a bracket for securing the wire guide to an external support, a housing, a holder for holding a nozzle extension, a main spring and an adjustment mechanism, and wherein the main spring is configured to allow the holder to float within the housing whilst a first end of the holder extends through an aperture formed in the housing and has a position adjustable with reference to the housing by the adjustment mechanism.

In accordance with an embodiment of the invention, the nozzle extension is configured to pass through the bracket and the holder, and a filler wire is configured to pass through the nozzle extension.

The main spring is preferably configured to bias the holder in a direction towards the bracket and preferably to hold a second end of the holder against the bracket whilst allowing the positioning of the first end of the holder to be adjusted using the adjustment mechanism.

The adjustment mechanism is configured to enable adjustment of the position of the first end of the holder relevant to a longitudinal centre line of the housing.

Preferably, adjustment is possible in the direction of both a notional X-axis and a notional Y-axis. The notional X-axis and notional Y-axis extend perpendicular to one another and perpendicular to a longitudinal centreline of the housing. Accordingly, such adjustment results in a substantially equivalent adjustment of the nozzle extension held by the holder along the notional X-axis and the notional Y-axis.

Preferably, the filler wire passes through the nozzle extension and the holder substantially coincident to the longitudinal centreline of the holder. However, the position of the longitudinal centreline of the filler wire relative to the housing will vary depending on the operation of the adjustment mechanism by a user.

The adjustment mechanism preferably includes a first and a second member each arranged to be located and moved each within an aperture in the housing. The apertures are preferably located substantially perpendicular to one another and substantially perpendicular to the longitudinal centre line of the housing. Each first and second member, which may be a threaded member such as a bolt, is arranged to move inwardly and outwardly of the aperture by a user so as to push against or retract from a respective part of the holder. The inward or outward path of travel of the first member is coincident with the notional X-axis and the inward or outward path of travel of the second member is coincident with the notional Y-axis. It will thus be appreciated that by adjusting the positioning of the first and second members within their respective apertures, it is possible to directly adjust the positioning of the holder within the housing. This in turn will cause an adjustment of the positioning of the free end of the filler wire.

Contact between each of the first and second members with the respective parts of the holder is maintained in use by respective biasing means. Each biasing means is preferably a spring and grub screw combination located in an aperture positioned opposite the aperture of the respective first or second member. The biasing means is provided and set to ensure that the holder will return to a centrally located position within the housing under the bias of the spring when both the first and second members are set to a zero position. In this position, in accordance with the preferred embodiment, the longitudinal centreline of the holder is coincident with the longitudinal centreline of the housing.

### BRIEF DESCRIPTION OF DRAWINGS

An embodiment of the invention will now be described, by way of example only, with reference to the accompanying drawings in which:

FIG. 1 is an isometric view of a wire guide according to an embodiment of the invention loaded with filler wire;

FIG. 2 is an assembly view of the wire guide shown in FIG. 1 without the filler wire;

FIG. 3 is a side isometric view of an upper part of the bracket of the wire guide shown in FIG. 1 fitted with a link and a connector;

FIG. 4 is a top view of the holder of the wire guide shown in FIG. 1;

FIG. 5 is a top view of the housing of the wire guide shown in FIG. 1; and

FIG. 6 is a top view of the nozzle extension of the wire guide shown in FIG. 1.

### DETAILED DESCRIPTION OF DRAWINGS

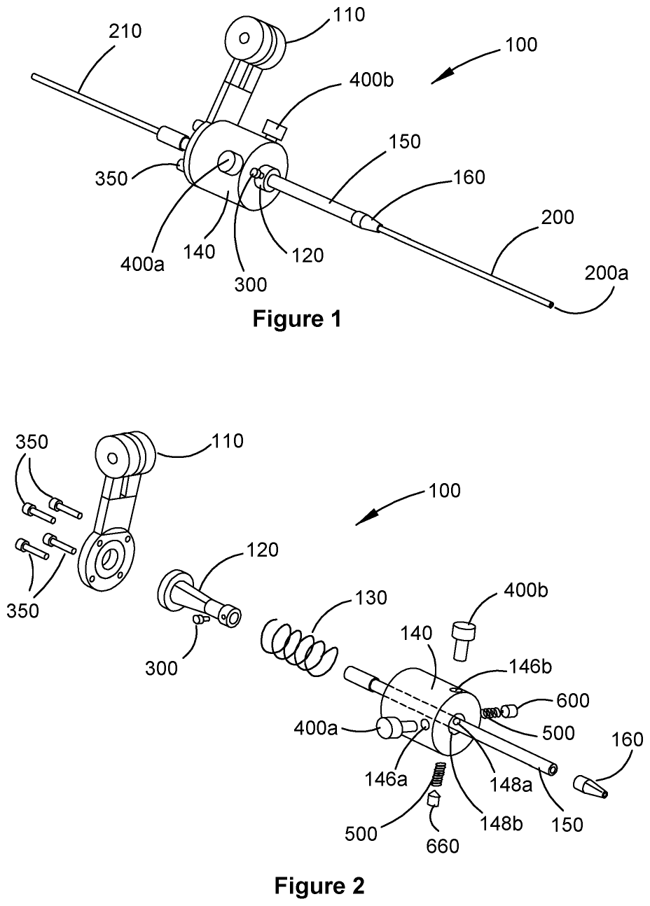

Wire guide 100 shown in FIGS. 1 and 2 includes bracket 110, holder 120, main spring 130, housing 140, and a nozzle extension 150. Preferably, a wire feed tip 160 is further included. In FIG. 1, a filler wire 200 is shown being fed from the rear of the wire guide 100, that is the side adjacent to the bracket 110, through the housing 140 of the wire guide 100, and exiting through the feed tip 160. The filler wire 200 is normally contained within a sheath 210 until about the point at which the filler wire 200 enters the nozzle extension 150.

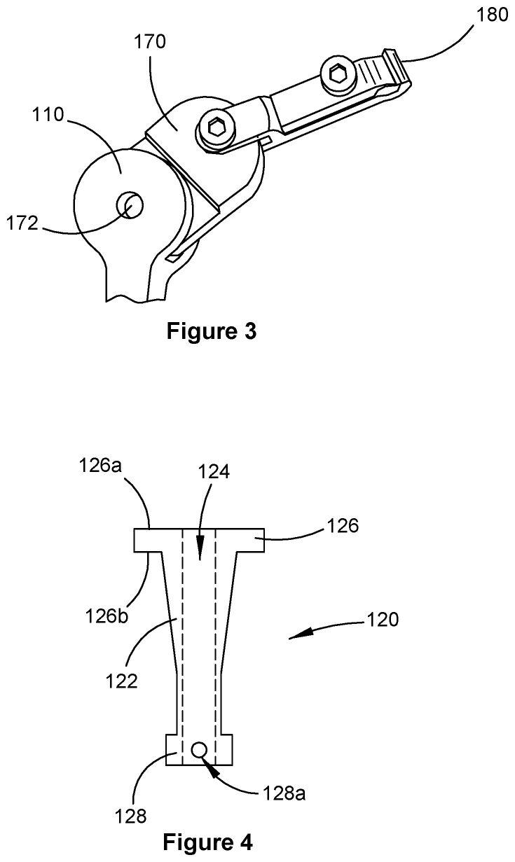

The wire guide 100 is typically arranged in use to be connected via the bracket 100 to an external support or other element not illustrated. The bracket 100 may for example be connected to a part of a welding apparatus (not shown). To this end, and as shown in FIG. 3, a link 170 may be provided and arranged for pivotal connection via pivot pin 172 to the upper part of the bracket 110. The pivotal connection of the link 170 to the bracket 110 enables the angular positioning of the wire guide 100 to be adjusted relative to the external support (not shown). The link 170 may be directly connected to the external support or a connector 180 may be attached between the link 170 and the external support.

FIG. 3 shows one example of a connector 180. However, a person skilled in the art will appreciate that both the configuration of the link 170 and the connector 180 may be varied to suit the particular application and the configuration of the external support to which the wire guide 100 is to be connected.

FIG. 4 further illustrates the holder 120. Holder 120 includes a body 122 with a through hole 124 formed therein through which the nozzle extension 150 may be passed. The through hole 124 is preferably dimensioned relative to the external diameter of the nozzle extension 150 to allow the nozzle extension 150 to be passed through the through hole 124 whilst limiting any potential side to side movement of the nozzle extension 150 therewithin.

Holder 120 has an enlarged trailing end (second end) formed by flange 126 and a leading end (first end) 128. The flange 126 has a generally planar first end face 126a and second end face 126b.

Flange 126 is dimensioned to snugly fit within the housing 140 whilst still allowing adjustment of the position of the leading end 128 of the holder 120 relative to the housing 140. This adjustment will be explained in more detail later.

As best shown in FIG. 4, the leading end 128 of the holder 120 includes a threaded hole 128a. In use, a fastener, such as a bolt 300 is arranged to be screwed into the hole 128a so that the innermost end thereof presses against a part of the nozzle extension 150 and in this way locates and secures the nozzle extension 150 within the holder 120. This prevents the nozzle extension 150 from moving side to side or longitudinally within the holder 120. The longitudinal axis of hole 128a is located perpendicular to the longitudinal axis of the through hole 124 of the holder 120.

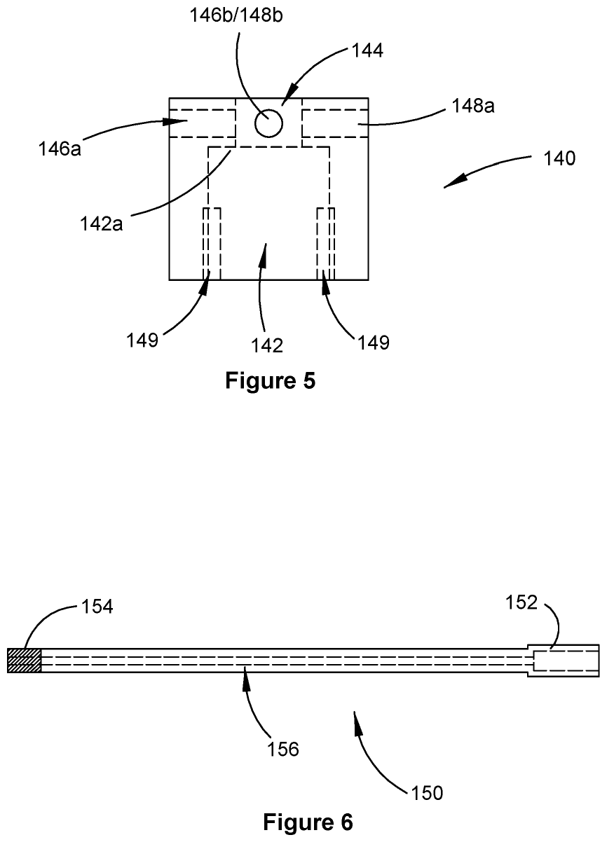

FIG. 5 best illustrates the housing 140. As shown, housing 140 includes a through opening which includes a major bore 142 and a minor bore 144. The housing 140 and major and minor bores 142, 144 are sized so that when the holder 120 is properly positioned within the housing 140 with bracket 110 secured thereto, the leading end 128 of the holder 120 passes through the minor bore 142 and is positioned as shown in FIG. 1. In this position, bolt 300 can be screwed into the hole 128a which is located externally of the housing 140.

The major bore 142 of the housing 140 is sized relative to the flange 126 of the holder 120 so that there is some limited ability for the holder 120 to move or float within the housing 140. However, that movement or float, as will be explained, is controllable by the main spring 300 and an adjustment mechanism.

Main spring 130 is arranged to sit over the holder 120 with one end located against the second end face 126b of the flange 126 of the holder 120 and the other end located against the bottom face 142a of the major bore 142. When the holder 120 is located within the major bore 142 of the housing 140 and the bracket 110 secured thereto, the main spring 130 is held under compression. Accordingly, the main spring 130 acts to push the holder 120 in the direction of the bracket 110 so that the first end face 126a of the flange 126 of the holder 120 is normally held in contact with the bracket 110. However, it should be appreciated that the holder 120 is not fixedly secured to any part of the housing 140 and thus it can “float” within the housing 140.

As shown, four screws 350 are used to secure the bracket 110 to the body of the housing 140. However, any suitable means for securing the bracket 110 to the housing 140 may be adopted.

The nozzle extension 150 is a tubular member, for example a length of copper tube. In accordance with the illustrated embodiment, the tubular member includes at one end, an enlarged external diameter portion 152 which is threaded internally. Such an arrangement is provided to enable the sheath 210 surrounding the filler wire 200 to connect thereto. The other end 154 of the tubular member is arranged, in accordance with the illustrated embodiment, for connection to the feed tip 160. To this end, the external periphery of the other end 154 is also threaded.

FIG. 6 clearly illustrates the through hole 156 within the nozzle extension 150. The filler wire 200 is arranged to be pushed through the through hole 156 during use of the wire guide 100.

Feed tip 160 includes a through hole through which the filler wire 200 passes. Different sized feed tips 160 may be provided to ensure a tight fit with different feed wire diameters. For example, the diameter of the through hole 156 of the nozzle extension 150 is typically set at 2 mm, whereas feed tips 160 with internal diameters of 1.1, 1.3 and 1.7 mm may be adopted for use with filler wire diameters of 0.9, 1.2 and 1.6 mm.

As best shown in FIGS. 2 and 5, the wire guide 100 includes an adjustment mechanism for adjusting the relative positioning of the free end 200a of the filler wire 200 relative to the housing 140. To this end, the housing 140 also includes two internally threaded thumb screw apertures 146a, 146b which are aligned with respective opposed grub screw apertures 148a, 148b. The two thumb screw apertures 146a, 146b each have a central axis which extends substantially perpendicularly to the longitudinal centreline through the housing 140 and perpendicularly to one another. In this way, the central axis of thumb screw aperture 146a defines a notional X-axis and the central axis of thumb screw aperture 146b defines a notional Y-axis. Each thumb screw aperture 146a, 146b is arranged to receive a screw 400a, 400b which can be rotated so as to be driven inwardly and outwardly of the respective apertures 146a, 146b.

Each grub screw aperture 148a, 148b is configured to receive a spring 500 and grub screw 600 combination. Each spring 500 and grub screw 600 combination is set within the respective grub screw aperture 148a, 148b so that in use the inner most end of the spring 500 contacts against a part of the periphery of the holder 120. Each spring 500 is held under compression. It will thus be appreciated that when the thumb screw 400a within the thumb screw aperture 146a is rotated to move inwardly of the aperture 146a, the distal end of the screw 400a will press against one side of the periphery of the holder 120, whilst the opposed side of the holder 120 will in turn press against the inner most end of the paired spring 500 to compress the same. Accordingly, the holder 120 will be pushed by the screw 400a along the notional X-axis and towards the grub screw 600. When the screw 400a within the thumb screw aperture 146a is rotated outwardly, the holder 120 will move back along the X-axis towards the screw 400a. In this way, the positioning of the holder 120 with the respect to the longitudinal centreline through the housing 140 can be adjusted in the direction of the notional X-axis. Similarly, adjustment in the direction of the notional Y-axis can be achieved by rotating the thumb screw 400b inwardly or outwardly of the aperture 146b. This fine adjustment of the positioning of the holder 120 within the housing 140 is possible because the holder 120 effectively “floats” within the housing 140 under the influence of the main spring 300 and any pressure applied to the holder 120 by the thumb screws 400a, 400b and springs 500.

It will thus be appreciated by a person skilled in the art that fine adjustment in the positioning of the holder 120 relative to the longitudinal centreline through the housing 140 can be achieved in both the X and Y axis direction. In turn, such an adjustment results in a corresponding or related adjustment in the positioning of the connected nozzle extension 150 and thus the filler wire 200 held within the nozzle extension 150. Thus, such fine positioning adjustment of the holder 120 within the housing 140 can be used to vary the position of the free end 200a of the filler wire 200 relative to the housing 140. Consequently, this fine adjustment can be used to vary the point at which the free end 200a of the filler wire 200 is located relative to the external support and in this way vary the position at which, for example, the filler wire would enter a weld pool.

The adjustment of the position of the free end 200a of the filler wire 200 can be quickly and easily made by a user simply by rotating one or both of the thumb screws 400a, 400b. Further, given the selected orientation of the thumb screws 400a, 400b and associated apertures 146a, 146b of the illustrated embodiment, the required adjustment of the positioning of the free end 200a of the filler wire 200 is directly translatable to the screws 400a, 400b. For example, when the free end 200a of the filler wire 200 needs to be moved forward in a direction parallel to the X-axis, then the X-axis screw 400a is simply rotated to move in the required direction. Similarly, when the free end 200a of the filler wire 200 needs to be moved rearward in a direction parallel to the Y-axis, then the Y-axis screw 400b is simply rotated to move in the required direction. In this way, the adjustment is deemed directed translatable which is intuitive for the user, thus making operation of the adjustment mechanism easier to learn and master.

The embodiments have been described by way of example only and modifications within the spirit and scope of the invention are envisaged.

1. A wire guide including a bracket for securing the wire guide to an external support, a housing, a holder for holding a nozzle extension, a main spring and an adjustment mechanism, and wherein the main spring is configured to allow the holder to float within the housing whilst a first end of the holder extends through an aperture formed in the housing and has a position adjustable with reference to the housing by the adjustment mechanism.

2. A wire guide according to claim 1 wherein the nozzle extension is configured to pass through the bracket and the holder, and a filler wire is configured to pass through the nozzle extension.

3. A wire guide according to claim 1 wherein the main spring is configured to bias the holder in a direction towards the bracket and to hold a second end of the holder against the bracket whilst allowing the positioning of the first end of the holder to be adjusted using the adjustment mechanism.

4. A wire guide according to claim 1 wherein the adjustment mechanism is configured to enable adjustment of the position of the first end of the holder relevant to a longitudinal centre line of the housing.

5. A wire guide according to claim 1 wherein adjustment of the first end of the holder is provided in the direction of both a notional X-axis and a notional Y-axis.

6. A wire guide according to claim 1 wherein the filler wire is configured to pass through the nozzle extension and the holder substantially coincident to a longitudinal centreline of the holder.

7. A wire guide according to claim 1 wherein the adjustment mechanism includes a first and a second member each arranged to be located and moved within aperture in the housing, the apertures located substantially perpendicular to one another and substantially perpendicular to the longitudinal centre line of the housing.

8. A wire guide according to claim 7 where each first and second member is arranged to be moved inwardly and outwardly of their respective aperture by a user so as to push against or retract from a respective part of the holder.

9. A wire guide according to claim 8 further including respective biasing means for maintaining contact between each of the first and second members and the respective parts of the holder.

10. A wire guide according to claim 9 wherein each biasing means includes a spring and grub screw combination located in an aperture positioned opposite the aperture of the respective first or second member.

11. A wire guide according to claim 10 wherein each biasing means is provided and set within their respective aperture to ensure that the holder will return to a centrally located position within the housing under the bias of the spring when both the first and second members are set to a zero position.
